(19) United States
(12) Patent Application Publication
(10) Pub. No.: US 2022/0011751 A1
(43) Pub. Date: Jan. 13, 2022

(54) METHOD FOR THE AUTOMATIC MONITORING OF A PRODUCTION PROCESS, AND A PRODUCTION PLANT AND COMPUTER PROGRAM THEREFOR

(71) Applicant: ENGEL AUSTRIA GmbH, Schwertberg (AT)

(72) Inventors: Josef GIESSAUF, Perg (AT); Richard DENK, Linz (AT); Johannes LETTNER, Perg (AT)

(21) Appl. No.: 17/369,488

(22) Filed: Jul. 7, 2021

(30) Foreign Application Priority Data
Jul. 10, 2020 (AT) A 50602/2020

(51) Int. Cl. G05B 19/418

(52) U.S. Cl. CPC G05B 19/4183; G05B 19/41835

(57) ABSTRACT

A method for automatic monitoring of a production process includes automatically determining a value of an indirect process quantity from at least one value of a process quantity. From the determined value, a preliminary reference value is determined, and a preliminary reference value is respectively allocated to a reference quantity. It is checked whether the preliminary reference value lies within a range of reference values permitted for the associated reference quantity. If not, the preliminary reference value is transformed into the permitted range of reference values and the transformed value corresponds to a limited reference value. Otherwise, the limited reference value corresponds to the preliminary reference value. It is checked whether at least one value of a monitored process quantity of the current production process represents an anomaly with regard to the limited reference value of the reference quantity, and/or a composite reference value of one composite reference quantity.

The invention relates to a method for automatic monitoring of a production process with the features of steps (a), (b), and (d) of claim 1, as well as a production plant according to claim 34 with means to execute the method of claim 1. In addition, the invention relates to a computer programme product according to claim 35.

For monitoring of a production process, initially, certain process quantities must be measured by a sensor or derived from measured data. The values of these process quantities can generally be time varying in the course of a process. In case of cyclical production processes, such as moulding processes of injection moulding machines, they can also have only one value per cycle and, for example, consist of identification numbers, such as minima, maxima, mean values, integrals, or values at a certain point in time of the time profile of another process quantity within a certain timeframe or cycle.

In addition, for monitoring the values of the process quantities, one or several reference value(s) must be determined. It is checked whether a certain value of a process quantity represents an anomaly with regard to one of its reference values. Typically, the reference values represent an upper and a lower monitoring limit for a process quantity, and thus generate a tolerance range for this process quantity. According to that, an anomaly is present, when the identification number lies outside the tolerance range.

In case of an anomaly, for example, a warning is issued to the operator, or the entire moulding cycle is being stopped. According to that, great importance is attached not only to the selection of suitable monitored process quantities, but also to a reasonable determination of the monitoring limits, i.e., the reference values for monitoring.

In the simplest case, determination of the reference values is undertaken manually by an operator. In this case, the reference values must be carefully selected by an experienced expert. Therefore, upon manual input, typically only few process quantities are monitored.

In current production plants, however, a plurality of sensors, and thus also a plurality of past values of process quantities, is available. Computer programme products currently offer the possibility to automatically form reference values for monitoring on the basis of indirect process quantities, such as mean values, expected values, or dispersion, which are determined from past values of process quantities. Automatic monitoring, including determination and graphic representation of monitoring limits, is known as quality control charts from the statistical process control. In that case, it is common to define two kinds of monitoring limits, stricter warning limits on the one hand and less strict intervention limits on the other hand.

A method for assessing and/or visualising a process state of a production plant is disclosed in DE 10 2019 105 230 A1. In this case, the process quantities are classified into logical groups, and then an assessment of the process state by means of comparing reference values and values of process quantities is performed for at least one logical group.

A further method for automatically finding reference values from past values of process quantities and for detecting anomalies is disclosed in DE 10 2018 107 233 A1. In this case, the reference values are determined from indirect process values, which are calculated from past values of process quantities. In this method, the reference values found are assessed for their quality. This assessment is carried out the same way as the determination of the reference values by using further indirect process values. In addition, following a detection of an abnormal value of a process quantity, a cause analysis is performed by an expert system, which interprets multiple threshold exceedings in a reasonable way s and notifies the operator about them in a comprehensible form and with concrete instructions for their elimination.

The determination of reference values as monitoring limits from past process values, however, provides monitoring limits which highly depend on the quality of the data and therefore are subject to a certain randomness. In case of a very little dispersion of the values of the process quantities, the monitoring can thus be very sensitive to small deviations, possibly irrelevant for the production process. In turn, in case of a very high dispersion, the monitoring limits are interpreted very generously. Then, relevant deviations may not be recognised any more, which can result in rejects (or a damage of the production plant).

The high number of monitored process quantities, which can be calculated by such an automatic method, should therefore still be checked by an operator. This monitoring of the monitoring limits or of reference values of such a high number, however, elaborate or even impossible. Thus, the benefit of such monitoring is limited.

The object of this invention is to avoid the disadvantages of the state of the art. In particular, an improved method, an improved production plant and an improved computer programme product are to be created.

According to the invention, this object is solved by a method with the features of claim 1, a production plant according to claim 34 and a computer programme product according to claim 35. Preferred embodiments of the present invention are indicated in the dependent claims.

With regard to the disclosure, the comparative word “higher” has two meanings: “truly higher” on the one hand and “higher than/equal to” on the other hand.

A method for automatic monitoring of a production process according to the invention, which is performed by a production plant for manufacturing at least one product, with
at least one process quantity of a number of process quantities,
at least one monitored process quantity of a number of monitored process quantities, wherein each monitored process quantity additionally belongs to the number of process quantities,
   comprises the following steps:
a. at least one value of at least one indirect process quantity of a number of indirect process quantities is automatically determined from at least one—preferably past—value of at least one process quantity of the number of process quantities,
b. for a number of reference quantities, at least one preliminary reference value is determined from the at least one determined value of at least one indirect process quantity of the number of indirect process quantities, wherein a preliminary reference value is respectively allocated to one reference quantity of the number of reference quantities and wherein a reference quantity is respectively allocated to at least one monitored process quantity,
c. for determination of a limited reference value of the at least one reference quantity, it is checked whether the preliminary reference value of the at least one reference quantity lies within a range of reference values permitted to the reference quantity, wherein, if this is not the case, the preliminary reference value is transformed, preferably shifted, into the permitted range of reference values, and otherwise the limited reference value corresponds to the preliminary reference value,
d. it is checked whether at least one value of at least one monitored process quantity of the current production process represents an anomaly with regard to
   i. at least one limited reference value of the at least one reference quantity, and/or
   ii. at least one composite reference value of a composite reference quantity, wherein the at least one composite reference value is determined from at least one limited reference value of the at least one reference quantity and at least one value of a indirect process quantity.

According to that, at least one reference value can be calculated which is based on the past values of at least one process quantity and flexibly adapts to them. By fitting the at least one reference value into a range of reference values permitted to it, it is additionally guaranteed that the at least one reference value does not exceed/fall below certain threshold values pre-defined in a reasonable manner.

In one embodiment, the permitted range of reference values of the at least one reference quantity of step (b) can be determined automatically.

It can be provided that the permitted range of reference values of the at least one reference quantity of step (b) is determined by means of
at least one value of at least one process quantity of the number of process quantities, which differs from at least one of those process quantities, from which the at least one value of at least one indirect process quantity of the number of indirect process quantities of step (a) was determined, and/or
at least one system configuration value of a number of system configuration quantities, and/or
at least one setting value of a number of setting quantities of the production process, and/or
at least one parameter class, and/or
at least one system configuration class, and/or
at least one input quantity from outside the production process, and/or
at least one identifier of at least one of the quantities and/or classes stated above and/or one relationship stored in the form of a table or a function.

In one embodiment, it is provided that the production plant comprises at least one moulding machine, by which a moulding process is performed.

In one embodiment, it is provided that the number of system configuration quantities comprises at least one descriptive quantity of the production plant performing the production process, in particular a machine quantity of the moulding machine, for example a screw diameter or a nominal closing force of the moulding machine, and that the number of setting quantities comprises at least one control quantity, for example a temperature with a target value or a target closing force.

In one embodiment, it is provided that the limited reference value of the at least one reference quantity and/or the composite reference value of the at least one composite reference quantity is checked by an operator by means of at least one operator interface and/or changed upon request of the operator prior to step (d). Thus, the operator can check whether the reference value makes sense to him/her.

In one embodiment, it is provided that a parameter classification unit classifies at least one process quantity of the number of process quantities into at least one parameter class, wherein the at least one parameter class of the at least one process quantity is automatically recognised from—preferably past—values of the at least one process quantity and/or is allocated by the operator and/or is factory-allocated.

In one embodiment, it is provided that a configuration classification unit allocates a number of system configuration quantities, setting quantities and/or process quantities to a system configuration class, with the system configuration class being allocated to at least one logical group, wherein logical groups, for example, are machine type, type of application, material of the product, or product group. The configuration classification unit can be trained by means of a machine learning method, which itself preferably has been trained with training data, with these training data comprising at least one system configuration value, at least one setting value and/or at least one past value of process quantities, particularly preferred of a plurality of machines, as input data, and, as output data, system configuration classes allocated by an expert. A supervised or an unsupervised machine learning method can be used.

Furthermore, it can be provided that the automatic determination of the permitted range of reference values of a reference quantity is carried out with at least one table, wherein the table preferably allocates at least one permitted range of reference values to at least one monitored process quantity, wherein the permitted range of reference values can particularly preferably be retrieved indicating the identifier and/or the parameter class of the at least one monitored process quantity.

In one embodiment, it is provided that the automatic determination of the permitted range of reference values of a reference quantity is carried out with at least one set of rules, wherein the input values of the at least one set of rules comprise
at least one value of at least one process quantity of the number of process quantities, which differs from at least one of the process quantities, from which the at least one value of at least one indirect process quantity of the number of indirect process quantities of step (a) was determined, and/or
at least one system configuration value of a number of system configuration quantities, and/or
at least one setting value of a number of setting quantities of the production process, and/or
at least one parameter class, and/or
at least one system configuration class, and/or
at least one input quantity from outside the production process, and/or
at least one identifier of at least one of the quantities and/or classes stated above.

In one embodiment, it is provided that at least one set of rules can be created manually by an expert and/or by means of a machine learning method and/or by means of known functional relationships, for example by creating a table.

For the creation of a set of rules, a table can be compiled by an expert. The retrieval of the set of rules then, for example, corresponds to the (automatic) looking-up in the table (“lookup table”), for example by means of an identifier of a quantity and/or a class.

In one embodiment, it is provided that the machine learning method of at least one set of rules is performed with training data, preferably originating from a plurality of production plants, wherein upon application of a machine learning method, the training data preferably comprises
at least one parameter class, and/or
at least one setting value, and/or
at least one system configuration value, and/or
at least one system configuration class, as input data and/or preferably comprises
at least one input of at least one desired, limited reference value, and/or
at least one correction of at least one desired, limited reference value by the operator as output data. In that respect, a supervised or an unsupervised learning method can be applied.

In one embodiment, it is provided that a preliminary permitted range of reference values of at least one reference quantity is calculated from several sets of rules and the permitted range of reference values used in step (c) is determined from the intersection of all preliminary permitted ranges of reference values of the reference quantity. This way, a permitted range of reference values that is better adapted can be determined.

In one embodiment, it is provided that the value of at least one reference quantity and/or at least one composite reference quantity, which is/are allocated to a selected process quantity, is determined by means of indirect process values, which in step (a) are calculated from at least one value of
at least one process quantity of the number of process quantities, which is allocated to the same parameter class as at least one selected process quantity, and/or
the at least one selected process quantity itself.

In one embodiment, it is provided that at least one limited reference value of a reference quantity and/or at least one composite reference value of a composite reference quantity is used as upper or lower monitoring limit of at least one monitored process quantity and that the at least one value of the at least one monitored process quantity is classified as an anomaly in step (d), if the at least one value of the monitored process quantity is greater than the upper monitoring limit or smaller than the lower monitoring limit.

In one embodiment, it is provided that the upper and/or the lower monitoring limit of at least one monitored process quantity is calculated from at least one value of the following indirect process quantities:
mean value of past values of at least one process quantity, and/or
scaled measure of dispersion of past values of at least one process quantity, which comprises at least one value, in particular a single value or an upper and a lower value.

In one embodiment, it is provided that the scaled measure of dispersion is scaled by the operator and/or automatically, preferably depending on the present parameter class and/or system configuration classes. This way, the sensitivity of the monitoring limits can be set.

In one embodiment, it is provided that the mean value is formed from an arithmetic mean, a trimmed mean and/or the median of the preferably past values of the at least one process quantity.

In one embodiment, it is provided that the at least one value of the scaled measure of dispersion corresponds to at least one preliminary reference value and/or the at least one preliminary reference value is calculated from the at least one value of the scaled measure of dispersion. In particular, the permitted range of reference values of a preliminary reference value determined from the upper value of the scaled measure of dispersion can differ from the permitted range of reference values of the preliminary reference value determined from the lower value of the scaled measure of dispersion. This way, for example, asymmetrical value distributions can be considered systematically.

In one embodiment, it is provided that after step (dii), the upper and/or the lower monitoring limit of at least one monitored process quantity corresponds to at least one composite reference quantity, preferably to the sum or the difference of the mean value and the at least one limited reference value, which is determined from the at least one value of the scaled measure of dispersion and is limited by its permitted range of reference values.

In one embodiment, it is provided that the preferably past values of one process quantity of the number of process quantities form a discrete and preferably chronologically ordered series, wherein the elements of the series are allocated to discretised points in time of a continuous (part of a) production process and/or to a cycle of a piece-wise production process.

In one embodiment, it is provided that for determining the value of an indirect process quantity, a selected number of elements of the series is used, wherein these elements are not necessarily adjacent in a time series, and wherein in particular the selected number of elements is selected by the operator and/or is stored in a table, wherein the table preferably allocates a number of elements to a process quantity, and/or is determined by at least one set of selection rules, wherein the input values of the at least one set of selection rules preferably comprise
at least one value of at least one process quantity of the number of process quantities (1), which differs from at least one of the process quantities, from which the at least one value of at least one indirect process quantity of the number of indirect process quantities of step (a) was determined, and/or
at least one system configuration value of a number of system configuration quantities, and/or
at least one setting value of a number of setting quantities of the production process, and/or
at least one parameter class, and/or
at least one system configuration class, and/or
at least one input quantity from outside the production process, and/or
at least one identifier of at least one of the quantities and/or classes stated above.

In one embodiment, it is provided that the transformation of at least one preliminary reference value of a reference quantity in step (c) into the range of reference values permitted to the reference quantity for definition of a limited reference value is carried out in such way that the transformed reference value lies in the permitted range of reference values and differs as little as possible from the preliminary reference value—possibly by considering a safety distance. Upon the consideration of the safety distance, the transformed reference value is not fitted exactly into the permitted range of reference values, but with a certain distance to the margins of the permitted range of reference values.

In one embodiment, it is provided that a notification is issued, when at least one preliminary reference value of a reference quantity is transformed into the range of reference values permitted to the reference quantity in order to form a limited reference value, wherein the notification can be addressed, in particular, to an operator.

In one embodiment, it is provided that the parameter classification unit automatically recognises the at least one parameter class of at least one monitored process quantity from the position of at least one preliminary reference value of a reference quantity with regard to the range of reference values permitted to the reference quantity.

In one embodiment, it is provided that at least one indirect process value of at least one indirect process quantity is assessed positively or negatively by an assessment unit. This way, for example, indirect process values can be sorted out in advance.

In one embodiment, it is provided that in case of a negative assessment of at least one indirect process value of at least one indirect process quantity by the assessment unit, other, preferably past, values of at least one process quantity, in particular other elements of the series of those process quantities from which the at least one indirect process value was determined, is selected, and from these newly selected, preferably past, values of process quantities, new indirect process values may be determined.

In one embodiment, it is provided that the assessment unit uses at least one assessment indirect process quantity, wherein the assessment indirect process quantity is an indirect process quantity, and fixed rules for the assessment of at least one indirect process quantity differing from the assessment indirect process quantity, wherein the at least one assessment indirect process quantity, for example, is the average slope of the, preferably past, values of at least one process quantity.

In one embodiment, it is provided that in case of a negative assessment of an indirect process value by the assessment unit, the new selection of the, preferably past, values of at least one process quantity is performed manually and/or automatically, in particular by using assessment indirect process quantities.

In one embodiment, it is provided that the determination of the value of the at least one indirect process quantity from values of at least one process quantity in step (a) is triggered manually and/or automatically, in particular due to fixed criteria, in both cases in particular during the production process.

The manual selection of new values and the triggering for the determination of values can be performed by a machine operator and/or centrally for an entire production plant.

In one embodiment, it is provided that the value of at least one indirect process quantity is continuously re-determined from values of the process quantities in fixed time steps and/or after a fixed number of cycles of a cyclical production process.

In one embodiment, it is provided that the value of at least one indirect process quantity is cumulatively determined from the, preferably past, values of the process quantities.

In one embodiment, it is provided that the values of at least one process quantity and/or at least one indirect process quantity are stored by a data recording unit.

Furthermore, a production plant with means is provided, wherein the means are suitable to execute the method described above.

A computer programme product, comprising commands, is also provided, wherein the commands cause the production plant stated above to execute the method described above.

It shall be noted that the method is suitable for cycle-based and continuous production processes. By this, the method is in particular suitable for execution in production plants, which include at least one injection moulding machine and/or at least one plastics extruder.

In addition, the movement and/or other activities of robots or robot gripper arms can also be checked. Then, the process quantities are quantities of movement and/or other quantities.

The process quantities can, in particular, also be multidimensional. For example, the position of a robot gripper arm can be indicated with two- or three-dimensional space coordinates. Then, the permitted range of reference values, in particular the permitted range of values for monitoring limits of the robot movement, is an area or a volume, respectively, for example a circle or a sphere, respectively.

The sending of data, which becomes necessary due to the use of data from a plurality of production machines and/or production plants, can be undertaken in an anonymised and/or non-anonymised manner.

Setting quantities are defined by the operator or a computer programme, for example by the method according to the invention for automatic monitoring of a production process and/or a control algorithm.

Examples for setting quantities of the production process are, in particular, control quantities and/or reference quantities. Control quantities can be, for example, command quantities, the current values of which correspond to target values, or quantities, which specify the type of control. Furthermore, these quantities can also be setting quantities for control algorithms of the production process. Reference quantities can be, for example, monitoring limits of a process quantity or quantities, which specify the type of monitoring.

Examples for setting quantities of a method or a computer programme are quantities, which specify, which set of rules is to be used. Furthermore, these can also be setting quantities of an expert system or a control algorithm of a production machine.

Process quantities are physical measurands of the production process or quantities derived therefrom. Process quantities describe the behaviour of the production process.

Indirect process quantities or identification numbers are quantities derived from one or several process quantities. Indirect process quantities or identification numbers can, for example, describe characteristics of a measuring curve of a process quantity or points in time, at which process quantities assume certain values, or, for example, be the standard deviation of several past values of a process quantity. Indirect process quantities and identification numbers are also quantities of behaviour.

Process quantities and/or indirect process quantities can comprise quality quantities, such as, for example, weight, dimensional accuracy, warpage and/or surface, in particular of components of the production machine and/or the production plant. These can be measured directly and/or derived from process quantities.

System configuration quantities are descriptive quantities and independent of setting quantities and quantities of behaviour. They describe, for example, characteristics of the material, the production machine, the customer, the tool, or the geographic location. For example, a characteristic of the production machine can be the machine type, and a characteristic of the customer can be the branch, in which he/she works.

According to that, the values of system configuration quantities only change in case of a change in the configuration, for example, of the tool, the customer, the production machine, or the like; in particular, they do not change during and/or due to the steps (a), (b), (c), and (d) of the method according to the invention or due to a production process.

A parameter class can, for example, summarise process quantities with the same unit, from the same section of the production process and/or from the same area or component of the production machine.

A system configuration class can, for example, summarise the types of production machines, the geographic regions of the location of a production machine/plant or also the branch of the customers.

The identifier of a quantity and/or a class is a number and/or a string, which is unambiguously allocated to the quantity or the class, respectively.

Embodiments of the invention are discussed based on the figures, in which:

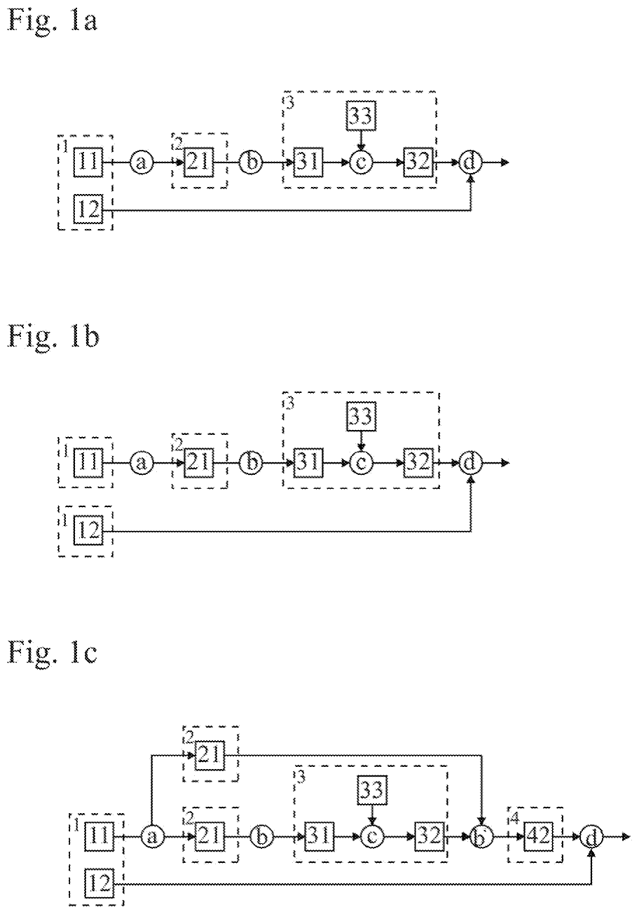

FIGS. 1a-c illustrate block diagrams of the quantities and values of simple embodiments of the method according to the invention

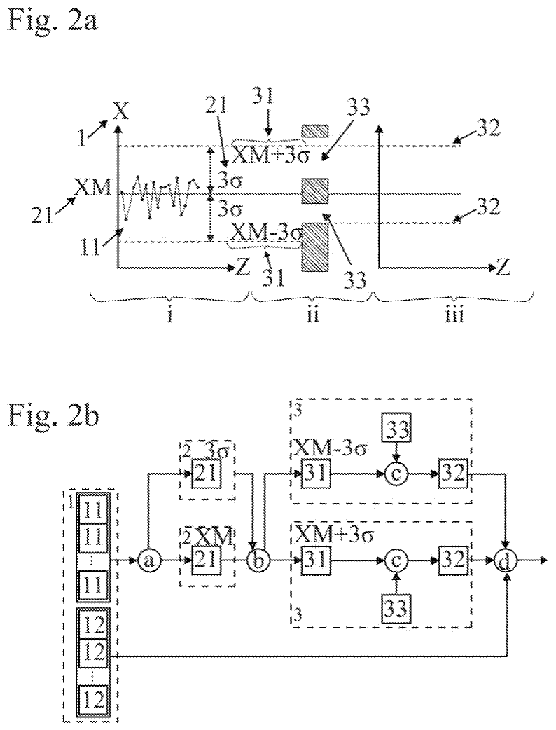

FIGS. 2a, b illustrate a typical embodiment with the fitting of absolute monitoring limits into a permitted range of reference values a. value chart of a process quantity with dispersion around a mean value, permitted range of values, monitoring limits. b. block diagram

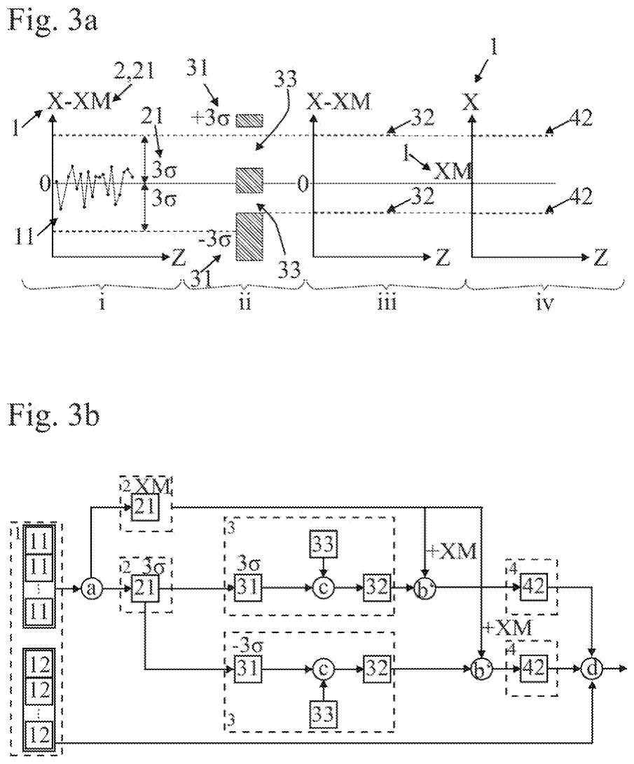

FIGS. 3a, b illustrate a typical embodiment with the fitting of relative monitoring limits into a permitted range of reference values. a. value chart of a process quantity with dispersion around a mean value, permitted range of reference values, monitoring limits. b. block diagram

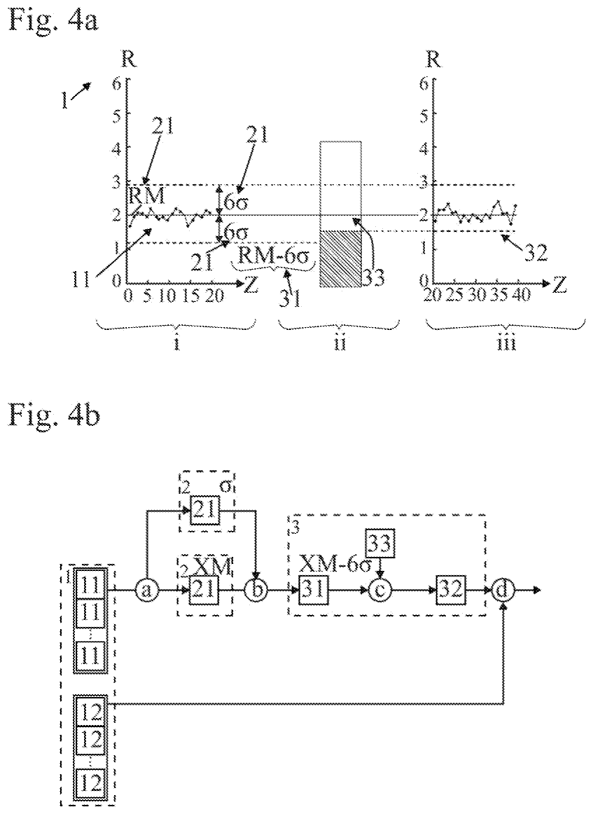

FIGS. 4a, b illustrate monitoring limits of the process quantity “remaining mass reserves” in an injection moulding process. a. value chart, permitted range of reference values, monitoring limits. b. block diagram

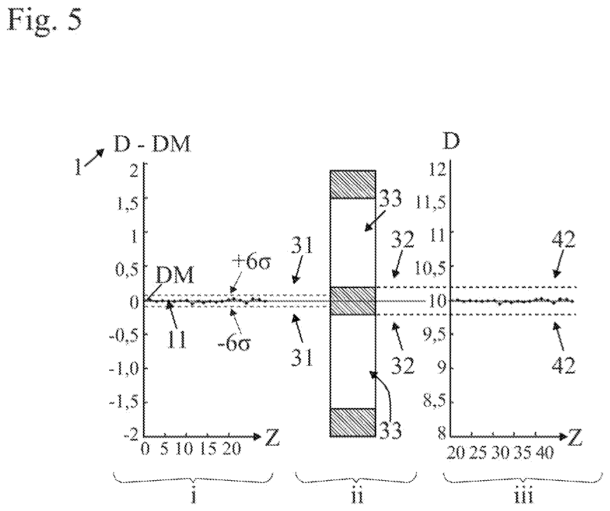

FIG. 5 illustrates monitoring limits of the process quantity “water flow rate in a cooling cycle of a tool” in an injection moulding process. a. value chart, permitted range of reference values, limited reference values, monitoring limits. b. block diagram

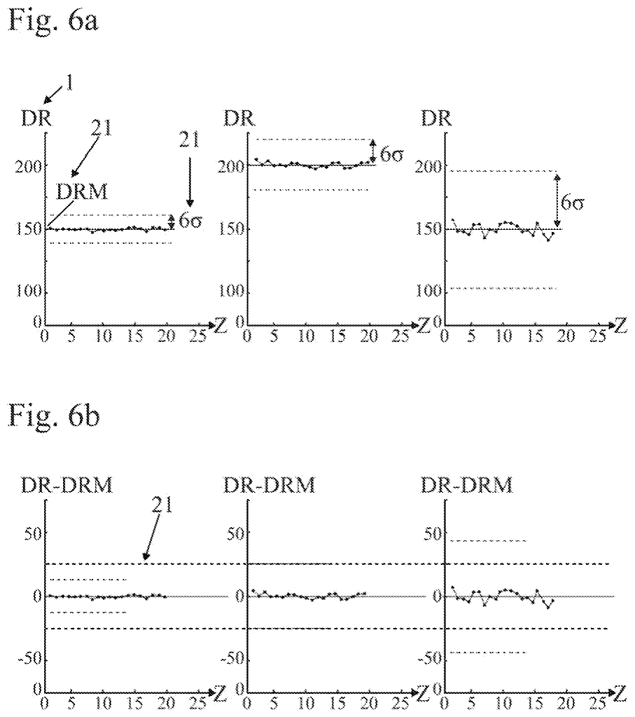

FIGS. 6a, b illustrate the averaging of monitoring limits of several machines

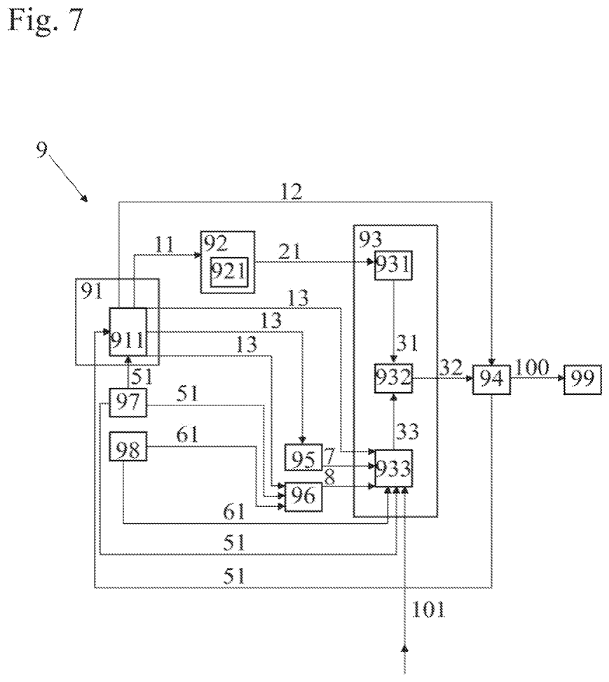

FIG. 7 illustrates a schematically represented production plant with a production machine with the production plant executing the method for monitoring of a production process

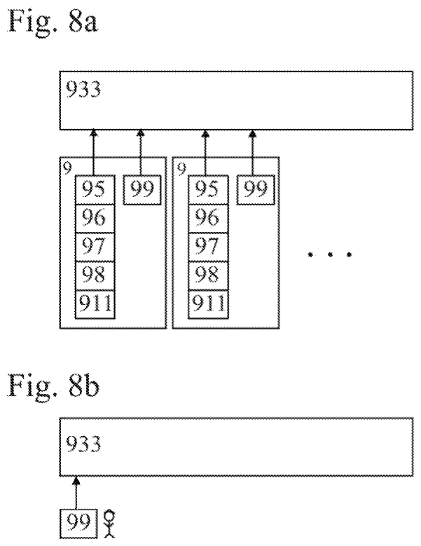

FIGS. 8a, b illustrate a learning method of the set of rules for determination of the permitted range of values for reference values

FIGS. 1a-c illustrate block diagrams for illustrating two simple embodiments of the method for automatic monitoring of exactly one process quantity 1. In FIG. 1a, a past value 11 of a process quantity 1 is used for checking a current value 12 of the same process quantity 1.

For that, in step a, an indirect process value 21 of an indirect process quantity 2 is first determined from the past value 11.

In the subsequent step b, a preliminary reference value 31 of a reference quantity 3 is determined from the indirect process value 21 of the indirect process quantity 2.

In step c, it is checked, whether the preliminary reference value 31 lies within a range of reference values 33 permitted to the reference quantity 3. If this is the case, then the preliminary reference value 31 is taken over for the limited reference value 32. If this is not the case, then the preliminary reference value 31 is transformed, in particular shifted, into the permitted range of values 33, and the transformed reference value is taken over for the limited reference value 32.

Transforming the preliminary reference value 31 into the permitted range of reference values 33 can be undertaken such that the transformed reference value differs as little as possible from the preliminary reference value 31. In general, any metric can be used as the measure for the difference of two reference values. In particular, “different” can mean the absolute value of the difference of two numerical values.

Also, in the general case of multidimensional process quantities 1, the metric can be chosen freely. In particular, the Euclidean metric can be used.

The limited reference value 32 is used to check, whether an anomaly is present for a current value 12 of the process quantity 1, wherein the process quantity 1 of the past value 12 corresponds to the checked process quantity 1. The checking is undertaken by a comparison of the current value 12 of the checked process quantity 1 with the limited reference value 32.

FIG. 1b illustrates a similar embodiment as FIG. 1a. In this embodiment, in the last step d, a current value 12 of a process quantity 1 is checked for an anomaly by means of the limited reference value 32, wherein the past value 11 originates from a different process quantity 1.

FIG. 1c illustrates an alternative, simple embodiment, wherein in this embodiment, it is checked whether at least one value 12 of at least one monitored process quantity 1 of the current production process 911 represents an anomaly with regard to at least one composite reference value 42 of a composite reference quantity 4. The at least one composite reference value 42 is determined from at least one limited reference value 32 of the at least one reference quantity 3 and at least one value 21 of an indirect process quantity 2. As in FIG. 1a, in this embodiment, a current value 12 of a process quantity 1 is checked for an anomaly, wherein the monitored process quantity 1 corresponds to that process quantity 1, from which the indirect process quantities 2 are determined.

Contrary to FIG. 1a, in FIG. 1c, respectively one indirect process value 21 of two indirect process quantities 2 are determined from the value 11 of the process quantity 1 in step a.

From one of these indirect process values 21, a preliminary reference value 31 of a reference quantity 3 is determined in step b. In step c, it is checked, whether this preliminary reference value 31 lies within a permitted range of reference values 33. If this is not the case, then the preliminary reference value 31 is transformed in such way that it lies within the permitted range of reference values 33. Thus, as set forth regarding FIG. 1a and FIG. 1b, a limited reference value 32 is determined.

In step b′, a further reference value 42 of a further reference quantity 4 is determined from the other indirect process value 21 and the limited reference value 32. This further reference quantity 4 is then used for checking for an anomaly of a current value 12 of a process quantity 1. This makes it possible that the reference value used for checking for an anomaly can also depend on a non-limited indirect process quantity 2. An example of such a typical case is shown in FIG. 5 and FIG. 6.

FIGS. 2a, b illustrate a typical embodiment of the method according to the invention for a cyclical production process 911 by means of diagrams (FIG. 2a) and a block diagram (FIG. 2b), as in FIGS. 1a-c. In this embodiment, twenty values 11 of a process quantity 1 of type X are present, respectively one value per production cycle Z.

At this point, it should be noted that the method according to the invention is not only suitable for cyclical production processes 911, such as moulding processes of an injection moulding machine, but also for continuous production processes 911, such as they are applied, for example, in plastics extruders.

As is apparent from section i of FIG. 2a, the values 11 of the process quantity 1 of type X fluctuate around a mean value XM. This mean value, here an arithmetic mean, represents an indirect process value 21 of an indirect process quantity 2 of the process quantity 1. A scaled measure of dispersion of the values 11 provides a second indirect process quantity 2 with its indirect process value 21, in this example the standard deviation 3σ of the values 11 of the process quantity 1 of type X multiplied by the factor three. These two indirect process values 21 are calculated in step a (see FIG. 2b).

As shown in section ii of FIG. 2a, the values 21 of the scaled measure of dispersion 3σ and the mean value XM respectively define a preliminary reference value 31 of two reference quantities 3 in step b. These values 31 correspond to XM+3σ and XM−3σ.

The reference quantities 3 can be used as an upper monitoring limit and a lower monitoring limit. Prior to that, however, the monitoring limits are checked. For that, both reference quantities 3 are allocated a permitted range of reference values 33. In step c (see FIG. 2b), the preliminary reference values 31 are shifted into the permitted range of reference values 33, if they do not already lie within the permitted range of reference values 33 anyway. Thus, in this embodiment, absolute monitoring limits are checked.

In the present example, the preliminary reference value 31 of the upper monitoring limit lies within its permitted range of reference values 33 and is thus not being shifted. According to that, the resulting limited reference value 32 is the same as the preliminary reference value 32 (see section iii of FIG. 2a).

In the present example, the preliminary reference value 31 of the lower monitoring limit does not lie within its permitted range of reference values 33. In order to obtain the limited reference value 32, the preliminary reference value 31 is shifted into the permitted range of reference values 33, namely in such way that it is located in the permitted range of reference values 33 and differs as little as possible from the original value. The resulting limited reference value 32 can be seen in section ii of FIG. 2a.

FIG. 2b illustrates a block diagram of the embodiment described in FIG. 2a. As is apparent in that embodiment, in a subsequent step d, the limited reference values 32 are compared with the current values 12 of the process quantities. If a value 12 of a process quantity is greater than the upper monitoring limit or smaller than the lower monitoring limit, then an anomaly is present. The block diagram is similar to the example in FIG. 1a.

FIGS. 3a, b illustrate, just as FIGS. 2a, b, a typical embodiment of the method according to the invention for a cyclical production process 911 by means of diagrams (FIG. 3a) and a block diagram (FIG. 3b), as in FIGS. 1a-c.

In this case, the same twenty values 11 of the process quantity 1 of type XM as in FIG. 2a are shown. Contrary to FIG. 2a, however, these are shown in section i on an axis shifted by the mean value XM.

In this case, the permitted range of reference values 33 applies to the relative monitoring limits around the mean value XM. The relative monitoring limits are indicated by 3σ and −3σ. As is also apparent in FIG. 2b, these relative monitoring limits are fitted into the range of reference values permitted to them. In that respect, the mean value XM does not play a role (it should be noted, that the axis of ordinates is shifted by the mean value XM). Therefrom result the fitted-in relative monitoring limits as the limited reference quantities 32 (see section iii of FIG. 3a).

In order to obtain absolute monitoring limits, which are suitable for comparison with current values 12 of a process quantity 1, in an additional step (b′), the mean value XM is added to the fitted-in, relative monitoring limits. In other words, this means that an indirect process value 21 (the mean value XM) can be added to the limited reference value 32 in an additional step.

Thus, the composite reference value 42 resulting therefrom is a value of an absolute monitoring limit, which can be used with a current value 12 of a process quantity 1 (see FIG. 3a, section iv, and FIG. 3b, step d). In this case, current values 12 of the same process quantity 1 are used as that one, from which the indirect process values 21 of mean value and standard deviation originate. I In that case it is to be considered that the axis of ordinates in section iv of FIG. 3a indicates absolute values of X.

FIGS. 4a, b illustrate the specification of monitoring limits for the remaining mass reserves in an injection moulding process, which is performed on an injection moulding machine. This embodiment is qualitatively similar to FIGS. 2a, b, since here, absolute monitoring limits are also fitted into a permitted range of reference values 33.

The process quantity 1 “remaining mass reserves” marks the volume remaining in front of the screw tip of an injection moulding machine at the end of the injection process. The value 11 cannot be set directly, but indirectly results from a series of setting values 51 of setting quantities 5. Thus, it is not known from the outset, it therefore is appropriate for the specification of monitoring limits to determine the value 11 in the ongoing production process 911.

In order to be able to always completely fill the mouldings manufactured by means of injection moulding despite common fluctuations in the production process 911, it must be ensured that the remaining mass reserves never reach the value of zero. Therefore, the permitted range of reference values 33 of the lower monitoring limit is limited from below with 1.5 cm³. Upwards, the permitted range of reference values 33 is unlimited in this embodiment. The value of the upper monitoring limit is uncritical for the production process 911, therefore the range of values is not restricted in this embodiment. It should be noted that, contrary to the embodiment in FIGS. 1c, 3 and 5, these are absolute monitoring limits, which are, in particular, not to be understood relative to a mean value.

The permitted range of reference values 33 can depend on system configuration quantities 6, such as, for example, the screw diameter. In the present embodiment, the lower limit of the permitted range of values can be calculated as 1.2% of the screw diameter to the third power; with a screw diameter of 5 cm, this then results in the value of 1.5 cm³ stated above for the lower limit of the permitted range of values 33.

In section i of FIG. 4a, twenty past values of the remaining mass reserves R are shown in units of cubic centimetres (cm³). From these, the arithmetic mean RM is formed as the first indirect process quantity 2, the indirect process value 21 in this case lies at around 2.04 cm³. As the second indirect process quantity 2, the standard deviation σ is calculated. This indirect process value 21 amounts to around 0.15 cm³. The six-fold standard deviation (6*0.15=0.9) is now subtracted from the mean value RM. Therefrom results the preliminary reference value 31 of the reference quantity 3 “lower monitoring limit” of 1.14 cm³. In order to determine the upper monitoring limit of 2.94 cm³, the six-fold standard deviation is added to the mean value.

Section ii of FIG. 4a shows the not-permitted (grey) or, respectively, the permitted range of values 33 for the lower monitoring limit. The preliminary reference value 31 of the lower monitoring limit lies at 1.14 cm³ and thus below the permitted range of values 33. Therefore, the lower monitoring limit is shifted to the smallest permitted value of 1.5 cm³.

Section iii of FIG. 4a shows the limited reference values 32 of the lower monitoring quantity and the upper monitoring limit as well as, for orientation, the indirect process value “arithmetic mean” RM. These limited reference values 32 are valid for the subsequent cycles.

FIG. 4b illustrates a block diagram similar to FIG. 2b for the embodiment of FIG. 4a. In this case, only the lower monitoring limit is shown as the reference quantity 3, as the upper monitoring limit is not fitted into a permitted range of reference values 33.

By way of example, FIG. 5 illustrates section i twenty past values of the process quantity 1 “flow rate” D in units of litre per minute (l/min). This process quantity 1 describes the measured water flow rate in a cooling cycle of a tool. From the twenty measurands, the arithmetic mean DM is determined as a first indirect process quantity 2 with a value of 10 l/min and the standard deviation σ as a second indirect process quantity 2 with a value of 0.012 l/min. It is to be considered that the axis of ordinates in section i is shifted by DM.

The standard deviation is multiplied by the factor six (or minus six) in order to obtain the preliminary reference values 31 of the reference quantities 3 “lower, relative monitoring limit” and “upper, relative monitoring limit”.

In this case, the twenty past values 11 by accident have a relatively small dispersion. If one would use the preliminary monitoring limits as actual monitoring limits, then the monitoring would be set very sensitively and would very often detect anomalies during running operation, which, however, have no relevance for the process and for the quality of the components manufactured.

In turn, it could also be the case that the twenty past values by accident or for unknown reasons have a very high dispersion. If one would use the preliminary monitoring limits obtained this way as actual monitoring limits, then the monitoring would be set on such an insensitive level that it would rarely or never detect an anomaly during running operation.

In order to avoid such cases, a range of values 33 of 0.25-1.5 l/min admissible for the reference quantity 3 “six-fold standard deviation” is defined, and the range of values mirrored around zero for the reference quantity 3 “negative six-fold standard deviation”. Therefrom result the permitted ranges of reference values 33 for the reference quantities 3 “upper, relative monitoring limit” and “lower, relative monitoring limit” represented in section ii of FIG. 5. The lower as well as the upper, relative monitoring limit must be shifted into the permitted ranges of reference values 33, so that the limits are changed as little as possible.

Adding the mean value DM (with a value of 10 l/min) to the preliminary reference values 3 shifted into the permitted range of reference values 33, that is to say the limited reference values 32, results in a “lower monitoring limit” of 9.75 l/min and an “upper monitoring limit” of 10.25 l/min (see section iii in FIG. 5). In the terminology used, these absolute monitoring limits represent composite reference values 42. In this case it is to be considered that the axis of ordinates in section iii (contrary to sections i and ii) indicates absolute values of the flow rate.

In order to reduce the randomness in the determination of indirect process quantities 2 described in the previous example, in some cases, values of process quantities 1 can be used, which were determined on various machines, at various points in time, in various heating zones, etc. This is illustrated in FIGS. 6a, b.

In that respect, the process quantities 1 should have a similar behaviour. In this embodiment, this is the case insofar, as here the torques are represented with units of Newton metres (Nm) upon dosing three machines identical in construction, which produce the same moulding with the same material (FIG. 6a).

In this case, the values of the indirect process quantities 2, mean value and dispersion, have intentionally been chosen very differently. From the dispersions, the indirect process values 31 of the indirect process quantities 3 are calculated for all three machines, with the values corresponding to the standard deviation multiplied by the factor six. For the indirect process quantity 2 “dispersion” this results in about 10 Nm, 15 Nm, and 45 Nm. In order to eliminate statistical outliers, the median of the dispersions (15 Nm) is formed.

The values are normalised by subtraction of the respective mean value (FIG. 6b). Now, the median of the indirect process values 31 is provided for further use as preliminary reference value 31. Thus, the values −15 Nm and 15 Nm are the result for the preliminary reference values 31 of the reference quantities 3 “lower, relative monitoring limit” and “upper, relative monitoring limit” for the three machines.

In one embodiment, the relative monitoring limits can now be fitted into the range of reference values 33 permitted to them, as in FIG. 3 and FIG. 5. In order to obtain absolute monitoring limits for a comparison with current values 12 of a process quantity 1, the mean value can be added after the fitting-in, in order to determine composite reference values 42.

In a further embodiment, the absolute upper and lower monitoring limits can be determined by adding the mean value prior to the fitting-in into the permitted range of reference values 33. In this case, the indirect process quantity 2 mean value results in values of 150 Nm, 200 Nm and 150 Nm for the three machines, wherein by this the lower and upper monitoring limits have the following values:

Machine 1: 135 and 165 Nm

Machine 2: 185 and 215 Nm

Machine 3: 135 and 165 Nm.

These absolute values can now, as for example in FIGS. 2a, b or FIGS. 4a, b, be fitted into a (absolute) permitted range of reference values 33. The limited reference values 32 resulting therefrom then represent the monitoring limits used.

For reasons of clarity, in this case, past values 11 of process quantities 1 of only three machines are represented. The approach becomes particularly useful with a higher number of machines.

FIG. 7 illustrates a schematically represented production plant 9 with a production machine 91, with the production plant 9 executing the method for monitoring a production process 911. The values transmitted are respectively indicated above the arrows, wherein in this case a reference designates at least one value; typically, however, this means several values.

For the determination of at least one preliminary reference value 31, preferably past, values 11 of at least one process quantity 1 are transmitted to a data recording unit 92. In the data recording unit 92, the values transmitted thereto are cached as at least one indirect process value 21. The data recording unit 92 performs an assessment of the cached at least one indirect process value 21, possibly by means of an assessment unit 921. The at least one indirect process value is transferred to the reference value determination unit 93, which calculates at least one preliminary reference value 31 by means of a unit for preliminary determination of a reference value 931. This at least one preliminary reference value 31 is transferred to the limiting unit 932.

A set of rules 933 is used for the determination of at least one permitted range of values 33. The set of rules 933 calculates the at least one permitted range of reference values 33 on the basis of input data, comprising
at least one value 13 of at least one process quantity 1, which differs from at least one of those process quantities 1, from which the at least one value 21 of at least one indirect process quantity 2 was determined, and which originates from the production process 911, and/or
at least one parameter class 7, which according to the embodiment originates from a parameter classification unit 95, and/or
at least one system configuration class 8, which according to the embodiment originates from a configuration classification unit 96, and/or
at least one setting value 51 of a setting quantity 5, and/or
at least one system configuration value 61 of a system configuration quantity 6, and/or
at least one input quantity 101 from outside the production process 911, and/or
at least one identifier of one of the quantities and/or classes stated above (not shown).

The parameter classification unit 95 determines the at least one parameter class 7 from past values 13 of at least one process quantity 1.

The configuration classification unit 96 determines the at least one system configuration class 8 from at least one past value 13 of a process quantity 1, at least one value 51 of a setting quantity 5 and/or at least one value of a system configuration quantity 61.

By knowing the at least one permitted range of values 33 and the at least one preliminary reference value 31, the limiting unit 932 determines at least one reference value 32. This at least one reference value 32 is used by the monitoring unit 94 for monitoring of at least one current value 12 of a process quantity 1. If the at least one current value 12 represents an anomaly with regard to the at least one reference value 32, then, according to the embodiment, a warning can be displayed on a operator interface 99 in the form of a text message 100 and/or the production process 911 can be stopped or re-parameterised by transmitting at least one setting value 51 of at least one setting quantity 5.

FIGS. 8a, b illustrate a schematic representation of the learning method of the set of rules 933. In FIG. 8a, the set of rules is trained by means of a machine learning method, wherein in this case the training data originates from a multitude of production plants 9. The data respectively originates from the parameter classification unit 95, the configuration classification unit 96, the control unit 97, the memory unit 98 and/or the production process 911. In addition, supervised machine learning can be applied, which additionally includes inputs or corrections of the reference values by an operator by means of the operator interface 99 for the training data.

In FIG. 8b, the set of rules 933 is manually created by an operator with expert knowledge by means of the operator interface 99. Furthermore, the set of rules 933 can be based on functional relationships.

### LIST OF REFERENCE SIGNS

1 Process quantity

11 Past value of a process quantity

12 Current value of a process quantity

13 Further past value of a process quantity
2 Indirect process quantity

21 Value of an indirect process quantity
3 Reference quantity

31 Preliminary reference value

32 Limited reference value

33 Permitted range of values for a reference value of a reference quantity
4 Composite reference quantity

42 Composite reference value
5 Setting quantity

51 Value of a setting quantity
6 System configuration quantity

61 Value of a system configuration quantity
7 Parameter class
8 System configuration class
9 Production plant

91 Production machine
911 Production process

92 Data recording unit
921 Assessment unit

93 Reference value determination unit
931 Unit for determining a preliminary reference value
932 Limiting unit
933 Set of rules

94 Monitoring unit

95 Parameter classification unit

96 Configuration classification unit

97 Control unit

98 Memory unit

99 operator interface
100 Text message
101 Input quantity from outside the production process

1. A method for automatic monitoring of a production process, which is performed by a production plant for manufacturing at least one product, with
at least one process quantity of a number of process quantities,
at least one monitored process quantity of a number of monitored process quantities, wherein each monitored process quantity additionally belongs to the number of process quantities,
and wherein
a. at least one value of at least one indirect process quantity of a number of indirect process quantities is automatically determined from at least one—preferably past—value of at least one process quantity of the number of process quantities,
b. for a number of reference quantities, at least one preliminary reference value is determined from the at least one determined value of at least one indirect process quantity of the number of indirect process quantities, wherein a preliminary reference value is respectively allocated to one reference quantity of the number of reference quantities and wherein one reference quantity is respectively allocated to at least one monitored process quantity,
c. for the determination of a limited reference value of the at least one reference quantity, it is checked, whether the preliminary reference value of the at least one reference quantity lies within a range of reference values permitted to the reference quantity, wherein, if this is not the case, the preliminary reference value is transformed, preferably shifted, into the permitted range of reference values, and otherwise, the limited reference value corresponds to the preliminary reference value,
d. it is checked whether at least one value of at least one monitored process quantity (1) of the current production process represents an anomaly with regard to
i. at least one limited reference value of the at least one reference quantity, and/or
ii. at least one composite reference value of a composite reference quantity, wherein the at least one composite reference value is determined from at least one limited reference value of the at least one reference quantity and at least one value of an indirect process quantity.

2. The method according to claim 1, wherein the permitted range of reference values of the at least one reference quantity is determined automatically.

3. The method according to claim 1, wherein the permitted range of reference values of the at least one reference quantity is determined by means of
at least one value of at least one process quantity of the number of process quantities, which differs from at least one of those process quantities, from which the at least one value of the at least one indirect process quantity of the number of indirect process quantities of step (a) was determined, and/or
at least one system configuration value of a number of system configuration quantities, and/or
at least one setting value of a number of setting quantities of the production process, and/or
at least one parameter class, and/or
at least one system configuration class, and/or
at least one input quantity from outside the production process, and/or
at least one identifier of at least one of the quantities and/or classes stated above and/or one relationship stored in the form of a table or a function.

4. The method according to claim 1, characterised in that the production plant comprises at least one moulding machine, by which a moulding process is performed.

5. The method according to claim 1, wherein the number of system configuration quantities comprises at least one descriptive quantity of the production plant performing the production process, in particular a machine quantity of the moulding machine, for example a screw diameter or a nominal closing force of the moulding machine, and that the number of setting quantities comprises at least one control quantity, for example a temperature with a target value or a target closing force.

6. The method according to claim 1, wherein the limited reference value of the at least one reference quantity and/or the composite reference value of the at least one composite reference quantity, prior to step (d), is checked by an operator by means of at least one operator interface and/or changed upon request of the operator.

7. The method according to claim 1, wherein a parameter classification unit classifies at least one process quantity of the number of process quantities into at least one parameter class, wherein the at least one parameter class of the at least one process quantity is automatically recognised from—preferably past—values of the at least one process quantity and/or is allocated by the operator and/or is factory-allocated.

8. The method according to claim 1, wherein a configuration classification unit allocates a number of system configuration quantities, setting quantities and/or process quantities to a system configuration class, with the system configuration class being allocated to at least one logical group, wherein logical groups, for example, are machine type, type of application, material of the product, or product group.

9. The method according to claim 1, characterised in that the automatic determination of the permitted range of reference values of a reference quantity is undertaken with at least one table, wherein the table preferably allocates at least one permitted range of reference values to at least one monitored process quantity, wherein the permitted range of reference values can particularly preferably be retrieved indicating the identifier and/or the parameter class of the at least one monitored process quantity.

10. The method according to claim 1, characterised in that the automatic determination of the permitted range of reference values of a reference quantity is undertaken with at least one set of rules, wherein the input values of the at least one set of rules preferably comprise
at least one value of at least one process quantity of the number of process quantities, which differs from at least one of the process quantities, from which the at least one value of at least one indirect process quantity of the number of indirect process quantities of step (a) was determined, and/or
at least one system configuration value of a number of system configuration quantities, and/or
at least one setting value of a number of setting quantities of the production process, and/or
at least one parameter class, and/or
at least one system configuration class, and/or
at least one input quantity from outside the production process, and/or
at least one identifier of at least one of the quantities and/or classes stated above.

11. The method according to claim 10, wherein at least one set of rules can be created manually by an expert and/or by means of a machine learning method and/or by means of known functional relationships, for example by creating a table.

12. The method according to claim 11, wherein the machine learning method of at least one set of rules is performed with training data, preferably originating from a plurality of production plants, wherein the training data, upon application of a machine learning method, preferably comprises
at least one parameter class, and/or
at least one setting value, and/or
at least one system configuration value, and/or
at least one system configuration class, as input data and/or preferably comprises
at least one input of at least one desired, limited reference value, and/or
at least one correction of at least one desired, limited reference value by the operator as output data.

13. The method according to claim 10, wherein a preliminary permitted range of reference values of at least one reference quantity is calculated from several sets of rules and the permitted range of reference values used in step (c) is determined from the intersection of all preliminary permitted ranges of reference values of the reference quantity.

14. The method according to claim 1, wherein the value of at least one reference quantity and/or at least one composite reference quantity, which is/are allocated to a selected process quantity, is/are determined by means of indirect process values, which in step (a) are calculated from at least one value of
at least one process quantity of the number of process quantities, which is allocated to the same parameter class as at least one selected process quantity, and/or
the at least one selected process quantity itself.

15. The method according to claim 1, wherein at least one limited reference value of a reference quantity and/or at least one composite reference value of a composite reference quantity is/are used as upper or lower monitoring limit of at least one monitored process quantity and that the at least one value of the at least one monitored process quantity is classified as an anomaly in step (d), if the at least one value of the monitored process quantity is greater than the upper monitoring limit or smaller than the lower monitoring limit.

16. The method according to claim 15, wherein the upper and/or the lower monitoring limit of at least one monitored process quantity is calculated from at least one value of the following indirect process quantities:
mean value of past values of at least one process quantity, and/or
scaled measure of dispersion of past values of at least one process quantity, which comprises at least one value, in particular a single value or an upper and a lower value.

17. The method according to claim 16, wherein the scaled measure of dispersion is scaled by the operator and/or automatically, preferably depending on the present parameter class and/or the system configuration classes.

18. The method according to at least one of claims 16, wherein the mean value is formed from an arithmetic mean, a trimmed mean and/or the median of the—preferably past—values of the at least one process quantity.

19. The method according to claim 16, wherein the at least one value of the scaled measure of dispersion corresponds to at least one preliminary reference value and/or the at least one preliminary reference value is calculated from the at least one value of the scaled measure of dispersion, wherein in particular the permitted range of reference values of a preliminary reference value determined from the upper value of the scaled measure of dispersion differs from the permitted range of reference values of the preliminary reference value determined from the lower value of the scaled measure of dispersion.

20. The method according to claim 16, characterised in that, after step (dii), the upper and/or the lower monitoring limit of at least one monitored process quantity correspond to at least one composite reference quantity, preferably to the sum or the difference of the mean value and the at least one limited reference value, which is determined from the at least one value of the scaled measure of dispersion and is limited by its permitted range of reference values.

21. The method according to claim 1, wherein the—preferably past—values of one process quantity of the number of process quantities form a discrete and preferably chronologically ordered series, wherein the elements of the series are allocated to discretised points in time of a continuous (part of a) production process and/or to a cycle of a piece-wise production process.

22. The method according to claim 21, wherein for determining the value of an indirect process quantity, a selected number of elements of the series is used, wherein these elements are not necessarily adjacent in a time series, and wherein in particular the selected number of elements is selected by the operator and/or is stored in a table, wherein the table preferably allocates a number of elements to a process quantity, and/or is determined by at least one set of selection rules, wherein the input values of the at least one set of selection rules preferably comprise
at least one value of at least one process quantity of the number of process quantities, which differs from at least one of the process quantities, from which the at least one value of at least one indirect process quantity of the number of indirect process quantities of step (a) was determined, and/or
at least one system configuration value of a number of system configuration quantities, and/or
at least one setting value of a number of setting quantities of the production process, and/or
at least one parameter class, and/or
at least one system configuration class, and/or
at least one input quantity from outside the production process, and/or
at least one identifier of at least one of the quantities and/or classes stated above.

23. The method according to claim 1, characterised in that the transformation of at least one preliminary reference value of a reference quantity in step (c) into the range of reference values permitted to the reference quantity for definition of a limited reference value is undertaken in such way that the transformed reference value lies within the permitted range of reference values and differs as little as possible from the preliminary reference value—possibly considering a safety distance.

24. The method according to claim 1, wherein a notification is issued, when at least one preliminary reference value of a reference quantity is transformed into the range of reference values permitted to the reference quantity for the formation of a limited reference value, wherein the notification, in particular, can be addressed to an operator.

25. The method according to claim 7, wherein the parameter classification unit automatically recognises the at least one parameter class of at least one monitored process quantity from the position of at least one preliminary reference value of a reference quantity with regard to the range of reference values permitted to the reference quantity.

26. The method according to claim 1, wherein at least one indirect process value of at least one indirect process quantity is assessed positively or negatively by an assessment unit.

27. The method according to claim 26, wherein, in case of a negative assessment of at least one indirect process value of at least one indirect process quantity by the assessment unit, other, preferably past, values of at least one process quantity, in particular other elements of the series of those process quantities, from which the at least one indirect process value was determined, are selected, and from these re-selected, preferably past, values of process quantities, new indirect process values are determined.

28. The method according to claim 27, wherein the assessment unit uses at least one assessment indirect process quantity, wherein the assessment indirect process quantity is a indirect process quantity, and fixed rules for the assessment of at least one indirect process quantity differing from the assessment indirect process quantity, wherein the at least one assessment indirect process quantity, for example, is the average slope of the, preferably past, values of at least one process quantities.

29. The method according to claim 28, wherein, in case of a negative assessment of a indirect process value by the assessment unit, the new selection of the, preferably past, values of at least one process quantity is performed manually and/or automatically, in particular using assessment indirect process quantities.

30. The method according to claim 1, wherein the determination of the value of the at least one indirect process quantity from values of at least one process quantity in step (a) can be triggered manually and/or automatically, in particular due to fixed criteria, in both cases in particular during the production process.

31. The method according to claim 1, characterised in that the value of at least one indirect process quantity is continuously re-determined from values of the process quantities in fixed time steps and/or after a fixed number of cycles of a cyclical production process.

32. The method according to claim 1, wherein the value of at least one indirect process quantity is cumulatively determined from the, preferably past, values of the process quantities.

33. The method according to claim 1, characterised in that the values of at least one process quantity and/or at least one indirect process quantity are stored by a data recording unit.

34. A production plant with means suitable to execute the method according to claim 1.

35. A computer program product, comprising commands to execute the method according to claim 1.
